(19) United States
(12) Patent Application Publication
(10) Pub. No.: US 2024/0138480 A1
(43) Pub. Date: May 2, 2024

(54) APPARATUS FOR HEATING AEROSOLISABLE MATERIAL

(71) Applicant: NICOVENTURES TRADING LIMITED, London (GB)

(72) Inventors: Andy SUTTON, London Greater London (GB); Conor MCGRATH, London Greater London (GB); Luke WARREN, London Greater London (GB); Matthew HODGSON, London Greater London (GB); Anton KORUS, Derby Derbyshire (GB)

(21) Appl. No.: 18/263,948

(22) PCT Filed: Feb. 7, 2022
(86) PCT No.: PCT/EP2022/052907

§ 371 Date: Aug. 2, 2023

(30) Foreign Application Priority Data
Feb. 10, 2021 (GB) 2101854.4

(51) Int. Cl. A24F 40/465; A24F 40/20

(52) U.S. Cl. CPC A24F 40/465; A24F 40/20

(57) ABSTRACT

An apparatus arranged to heat smokable material to volatilize at least one component of the smokable material is described. The apparatus has a heating assembly including a heating cavity arranged to receive at least a portion of an article including aerosolizable material. The apparatus also has a heating element arranged to provide heat to the heating cavity, the heating element including a heat pipe.

### PRIORITY CLAIM

The present application is a National Phase entry of PCT Application No. PCT/EP2022/052907, filed Feb. 7, 2022, which claims priority from GB Application No. 2101854.4, filed Feb. 10, 2021, each of which is hereby fully incorporated herein by reference.

### TECHNICAL FIELD

The present disclosure relates to an apparatus for heating aerosolizable material to volatize at least one component of the aerosolizable material. The present disclosure also relates to an elongate heating element for use in apparatus for heating aerosolizable material, an aerosol provision device and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an apparatus for heating aerosolizable material to volatize at least one component of the aerosolizable material, the apparatus comprising: a heating assembly comprising a heating cavity arranged to receive at least a portion of an article comprising aerosolizable material; a heating element arranged to provide heat to the heating cavity; and a heating arrangement configured to generate heat to heat the heating element; wherein the heating element comprises a heat pipe.

The heating element may protrude in the heating cavity.

The heating element may have an effective thermal conductivity of greater than 3000 W/m-k.

The heat pipe may protrude in the heating cavity.

The heat pipe may be an elongate member.

The heat pipe may have an envelope and a working fluid. The heat pipe may have a wick.

The heat pipe may be configured to be at least partially received in the article comprising aerosolizable material.

The heating element may comprise a sharp edge or point at a free end. The heating element may be a pin or blade. The heating element may be configured to extend into the article received by the heating region.

The heat pipe may be configured to distribute heat along the heating element.

The heat pipe may be arranged to transfer heat external to the heating cavity into the heating cavity.

The heating arrangement may be an induction heating arrangement. The heating arrangement may be a resistive heating arrangement.

The heating arrangement may be configured to apply heat at one end of the heat pipe.

The heating arrangement may at least partially encircle part of the heat pipe. The heating arrangement may encircle part of the heat pipe.

A portion of the heat pipe may extend away from the heating arrangement.

The apparatus may comprise a portion of the heat pipe extending external to the heating cavity.

The heating assembly may comprise an end wall defining a closed end of the heating cavity, and the heat pipe may extend beyond the end wall.

The heat pipe may extend through the end wall. The heating element may form at least part of the end wall.

The heating arrangement may be arranged to heat the portion of the heat pipe extending external to the heating cavity.

The apparatus may comprise a collar configured to heat the heat pipe.

The collar may extend around part of the heat pipe. The collar may extend around one end of the heat pipe. The collar may be tubular. The collar may be a foil layer. The collar may be a mesh. The susceptor may be a wire formed as a winding. The wire may have a serpentine arrangement. The collar may be a solid member.

The collar may comprise heating material that is heatable by penetration with a varying magnetic field.

The collar may be a ferrous material.

The heat pipe may be a non-ferrous material. The collar may conductively heat the heat pipe. The heat pipe may be indirectly heated by the heating arrangement.

The heat pipe may comprise heating material that is heatable by penetration with a varying magnetic field.

The heat pipe may be a ferrous material. The heat pipe may be directly heated by the heating arrangement.

The heating arrangement may comprise a magnetic field generator including an inductor coil configured to generate a varying magnetic field.

The inductor coil may be a helical inductor coil.

The inductor coil may be axially offset from the heating chamber.

The apparatus may comprise a receptacle defining the heating chamber. The inductor coil may not overlap the receptacle.

The receptacle may comprise an end wall defining a closed end of the heating zone, and the end wall may be between the heating zone and the inductor coil.

The heat pipe may define a longitudinal axis, and the inductor coil may be spaced from the heating chamber in the axial direction.

The inductor coil may be a spiral inductor coil. The inductor coil may be a planar coil.

The inductor coil may overlap the heating chamber.

The heating arrangement may be a resistive heating arrangement. The collar may be a resistive heater.

In use, the heating arrangement may be configured to heat the heat pipe to a temperature of between about 200° C. and about 350° C., such as between about 240° C. and about 300° C., or between about 250° C. and about 280° C.

The heat pipe may extend between the heating arrangement and the heating chamber.

The heat pipe may be tubular.

The heat pipe may be a flat heat pipe.

The inductor coil may be supported on a mount.

The inductor coil may comprise a wire. The inductor coil may comprise a conductive film.

The elongate heating element may define a longitudinal axis. The inductor coil may be spaced from the heating zone in the axial direction.

The heat pipe may upstand from a base.

A maximum width of the helical inductor coil may be less than a maximum width of the heating zone.

An inner diameter of the helical inductor coil may be less than an outer diameter of the heating zone.

A maximum outer width of the helical inductor coil may be less than a maximum outer width of the heating zone.

A maximum outer diameter of the helical inductor coil may be less than a maximum outer diameter of the receptacle.

The heating element may comprise a first portion exposed to the heating zone, and a second portion external to the heating zone. The helical inductor coil may encircle the second portion.

The first and second portions may be integrally formed. As used herein, the term ‘integrally formed’ is intended to mean that the features are not separable.

The second portion may be fluidly isolated from the heating zone.

The first portion may be a heating portion. The second portion may be a base portion. The heating portion and base portion may be co-axial.

The heating portion and base portion may be thermally conductively connected between. As used herein, the term ‘conductively connected between’ does not necessarily mean that two features are directly connected between, and such an arrangement may include one or further features therebetween. The heating portion and base portion may be thermally directly conductively connected therebetween. The heating portion and base portion may be thermally indirectly conductively connected therebetween, for example by an intermediate member. As used herein, the term ‘conductively connected between’ is intended to mean the primary means of heat transfer between the heating portion and base portion.

The heat pipe may have a lower susceptibility to being heated by penetration with the varying magnetic field than the susceptibility of the collar.

The heating element may be formed as a one part component. That is, the features are formed together such that no joints are defined therebetween.

According to an aspect, there is provided an apparatus for heating aerosolizable material to volatize at least one component of the aerosolizable material, the apparatus comprising: a heating assembly comprising a heating cavity arranged to receive at least a portion of an article comprising aerosolizable material; a heating element arranged to provide heat to the heating cavity; and a heating arrangement configured to generate heat to heat the heating element; wherein the heating element has an effective thermal conductivity of greater than 3000 W/m-k.

The thermal conductivity may be greater than 4000 W/m-k. The thermal conductivity may be greater than 5000 W/m-k.

According to an aspect, there is provided an apparatus for heating aerosolizable material to volatize at least one component of the aerosolizable material, the apparatus comprising: a heating assembly comprising a heating cavity arranged to receive at least a portion of an article comprising aerosolizable material; and a heating element arranged to provide heat to the heating cavity; wherein the heating element has an effective thermal conductivity of between 3000 and 100000 W/m-k.

The heating element may have an effective thermal conductivity of between 4000 and 10000 W/m-k.

The heat pipe may be formed from one of copper, aluminum, and austenitic nickel chromium. The heat pipe may be formed from stainless steel.

The heat pipe may comprise a working fluid having an operating temperature, in use, of about 200° C. and about 350° C., such as between about 240° C. and about 300° C., or between about 250° C. and about 280° C.

The heat pipe may comprise a working fluid comprising water. The heat pipe may comprise a working fluid comprising one or more of acetone, carbon dioxide, and ammonia.

The heat pipe may be formed with a body comprising copper and a working fluid comprising water. The heat pipe may be formed with a body comprising aluminum and a working fluid comprising ammonia. Other combinations are contemplated.

The apparatus of these aspects can include one or more, or all, of the features described above, as appropriate.

According to an aspect, there is provided an elongate heating element for use in apparatus for heating aerosolizable material to volatilize at least one component of the aerosolizable material, wherein the elongate heating element comprises a heat pipe. The susceptor portion may be heatable by penetration with a varying magnetic field.

According to an aspect, there is provided an aerosol provision device comprising at least one of the apparatus as set out above.

According to an aspect, there is provided an aerosol provision device comprising at least one of the elongate heating elements as set out above.

According to an aspect, there is provided an aerosol provision device comprising at least one of the apparatus as set out above and at least one of the elongate heating elements as set out above.

The aerosol provision device may be a non-combustible aerosol provision device.

The device may be a tobacco heating device, also known as a heat-not-burn device.

According to an aspect, there is provided an aerosol provision system comprising an aerosol provision device described above, and an article comprising aerosol generating material.

The article may be a consumable.

The aerosol generating material may be non-liquid aerosol generating material.

The article may be dimensioned to be at least partially received within the heating region.

### BRIEF DESCRIPTION OF THE DRAWINGS

Embodiments will now be described, by way of example only, and with reference to the accompanying drawings in which:

FIG. 1 shows a front perspective view of an aerosol provision device.

FIG. 2 shows schematically the aerosol provision device of FIG. 1.

FIG. 3 shows a side view of part of a heating assembly of FIG. 2 with an article comprising aerosol generating material.

FIG. 4 shows a cross-sectional side view of part of the heating assembly of FIG. 3 with the article comprising aerosol generating material.

FIG. 5 shows schematically a perspective view of the heating assembly of FIG. 3.

FIG. 6 shows schematically a side view of another heating assembly of the aerosol provision device of FIG. 2.

FIG. 7 shows schematically a side view of another heating assembly of the aerosol provision device of FIG. 2.

FIG. 8 shows schematically a side view of another heating assembly of the aerosol provision device of FIG. 2.

FIG. 9 shows schematically a side view of another heating assembly of an aerosol provision device.

### DETAILED DESCRIPTION OF THE DRAWINGS

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

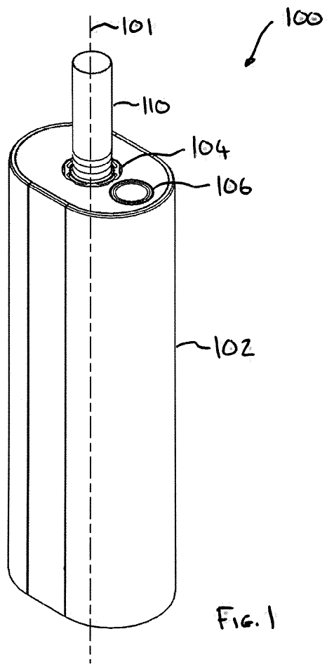

FIG. 1 shows an example of an aerosol provision device 100 for generating aerosol from an aerosol generating medium/material. The device 100 can be used to heat a replaceable article 110 comprising the aerosol generating medium, to generate an aerosol or other inhalable medium which can be inhaled by a user of the device 100.

The device 100 comprises a housing 102 which surrounds and houses various components of the device 100. The device 100 has an opening 104 in one end, through which the article 110 can be inserted for heating by the device 100. The article 110 may be fully or partially inserted into the device 100 for heating by the device 100.

The device 100 may comprise a user-operable control element 106, such as a button or switch, which operates the device 100 when operated, e.g. pressed. For example, a user may activate the device 100 by pressing the switch 106.

The device 100 defines a longitudinal axis 101, along which an article 110 may extend when inserted into the device 100.

FIG. 2 is a schematic illustration of the aerosol provision device 100 of FIG. 1, showing various components of the device 100. It will be appreciated that the device 100 may include other components not shown in FIG. 2.

As shown in FIG. 2, the device 100 includes an apparatus for heating aerosolizable material 200. The apparatus 200 includes a heating assembly 201, a controller (control circuit) 202, and a power source 204. The apparatus 200 comprises a body assembly 210. The body assembly 210 may include a chassis and other components forming part of the device. The heating assembly 201 is configured to heat the aerosol generating medium of an article 110 inserted into the device 100, such that an aerosol is generated from the aerosol generating medium. The power source 204 supplies electrical power to the heating assembly 201, and the heating assembly 201 converts the supplied electrical energy into heat energy for heating the aerosol generating medium.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The battery 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 100 closest to the opening 104 may be known as the proximal end (or mouth end) 107 of the device 100 because, in use, it is closest to the mouth of the user. In use, a user inserts an article 110 into the opening 104, operates the user control 106 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end 108 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

The heating assembly 201 may comprise various components to heat the aerosol generating material of the article 110 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

The apparatus 200 includes a heating chamber 211 configured and dimensioned to receive the article 110 to be heated. The heating chamber 211 defines a heating zone 215. In the present example, the article 110 is generally cylindrical, and the heating chamber 211 is correspondingly generally cylindrical in shape. However, other shapes would be possible. The heating chamber 211 is formed by a receptacle 212. The receptacle 212 includes an end wall 213 and a peripheral wall 214.

The heating chamber 211 is defined by the inner walls of the receptacle 212. The receptacle 212 acts as a support member. The receptacle comprises a generally tubular member extending along and around and substantially coaxial with the longitudinal axis 101 of the device 100. However, other shapes would be possible. The receptacle 212, and so heating chamber 211, is open at its proximal end such that an article 110 inserted into the opening 104 of the device 100 can be received by the heating chamber 211 therethrough. The receptacle 212 is closed at its distal end by the end wall 213. The receptacle 212 may comprise one or more conduits that form an air passage. In use, the distal end of the article 110 may be positioned in proximity or engagement with the end of the heating chamber 211. Air may pass through the one or more conduits, into the heating chamber 211, and flow through the article 110 towards the proximal end of the device 100.

The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 100. The receptacle 212 may be formed from a rigid material to aid support of other components.

Other arrangements for the receptacle 212 would be possible. For example, in an embodiment the end wall 213 is defined by part of the heating assembly 201, for example a circumferentially extending flange.

As illustrated in FIG. 2, the heating assembly 201 comprises a heating element 220. The heating element 220 is configured to heat the heating zone 215. The heating zone 215 is defined in the heating chamber 211. In embodiments the heating chamber 211 defines a portion of the heating zone 215 or the extent of the heating zone 215.

The heating element 220 comprises a heat pipe 230. The heat pipe 230 acts as a heat-transfer device. The heat pipe 230 comprises an envelope and a working fluid. The working fluid acts to transfer heat along the heat pipe from a heated end to a lower temperature end.

A heat pipe 230 is a closed evaporator-condenser system. The heat pipe includes a sealed, hollow tube. A wick is disposed in the tube. The inside walls of the heat pipe are lined with a capillary structure or wick. A thermodynamic working fluid, having substantially vapor pressure at the desired operating temperature, saturates the pores of the wick in a state of equilibrium between liquid and vapor. When heat is applied to the heat pipe, the liquid in the wick is heated causing the fluid to evaporate. The evaporated fluid fills a hollow center of the heat pipe and diffuses throughout its length.

With respect to the forgoing, tubular is intended to mean a member with a central bore. Such a heat pipe may be an elongate member, a plate, or have another cross-sectional appearance.

The heat pipe is formed from copper. The working fluid is water. Other configurations are anticipated. For example, the heat pipe may be formed from one of copper, aluminum, and austenitic nickel chromium. The heat pipe may be formed from stainless steel. The heat pipe may comprise a working fluid comprising water. The heat pipe may comprise a working fluid comprising one or more of acetone, carbon dioxide, and ammonia.

The heat pipe in embodiments includes a working fluid having an operating temperature, in use, of about 200° C. and about 350° C., such as between about 240° C. and about 300° C., or between about 250° C. and about 280° C.

With such configurations, the heating element has an effective thermal conductivity of greater than 3000 W/m-k, such as greater than 4000 W/m-k, and such as greater than 5000 W/m-k.

In embodiments, the heating element has an effective thermal conductivity of between 3000 and 100000 W/m-k, and such as between 4000 and 10000 W/m-k.

Effective thermal conductivity of a heat pipe may be calculated, for example based on a function of adiabatic, evaporator and condenser lengths, as set out in the equation below:

Keff=QLeff/(AΔT)
where:
   Keff=Effective thermal conductivity [W/m·K]
   Q=Power transported [W]
   L_{eff}=Effective length=(Lₑᵥₐₚₒᵣₐₜₒᵣ+L_{condenser})/2+L_{adiabatic} [m]
   A=Cross-sectional area [m²]
   ΔT=Temperature difference between evaporator and condenser sections [° C.]

The heat pipe comprises an evaporation region, that is the portion of the heat pipe receiving the input heat (heat addition); an adiabatic region, that is the portion of the tube transporting the vapor flow; and a condenser region, that is the portion of the heat pipe that effectively heats the aerosolizable material (heat rejection). The Lₑᵥₐₚₒᵣₐₜₒᵣ is the length of the evaporation region; the L_{condenser} is the length of the condenser region; and the L_{adiabatic} is the length of the adiabatic region.

The heat pipe 230 has a diameter of about 3 mm. The diameter of the heat pipe in embodiments is between about 1 mm and 10 mm, such as between about 2 mm and 5 mm, and such as between about 3 mm and 4 mm.

The heat pipe 230 has a length of about 50 mm. The length of the heat pipe in embodiments is between about 10 mm and 100 mm, such as between about 30 mm and 70 mm, and such as between about 40 mm and 60 mm.

The heating element 220 is heatable to heat the heating zone 215. The heating element 220 is an induction heating element. That is, the heating element 220 comprises a susceptor that is heatable by penetration with a varying magnetic field. The heating element 220 comprises the heat pipe 230 and a collar 225. The collar may be omitted as described below. The heating element 220 comprises a first portion, herein referred to as a heating portion 221, and a second portion, herein referred to as a base portion 222. At least part of the base portion 222 acts as the susceptor. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating assembly 201 comprises a magnetic field generator 240, acting as a heating arrangement. The magnetic field generator 240 is configured to generate one or more varying magnetic fields that penetrate the susceptor so as to cause heating in the susceptor. The magnetic field generator 240 includes a helical inductor coil 241, acting as an inductor element, and shown schematically in FIG. 2.

In some examples, in use, the inductor coil is configured to heat the susceptor to a temperature of between about 200° C. and about 350° C., such as between about 240° C. and about 300° C., or between about 250° C. and about 280° C.

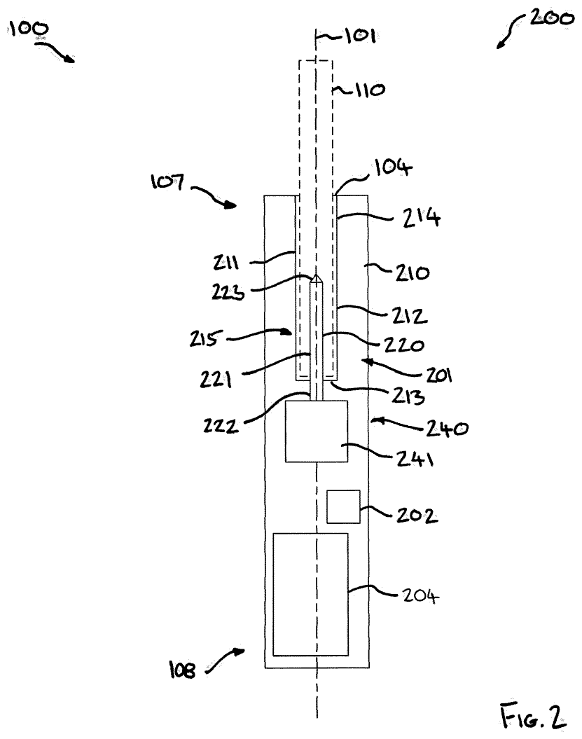

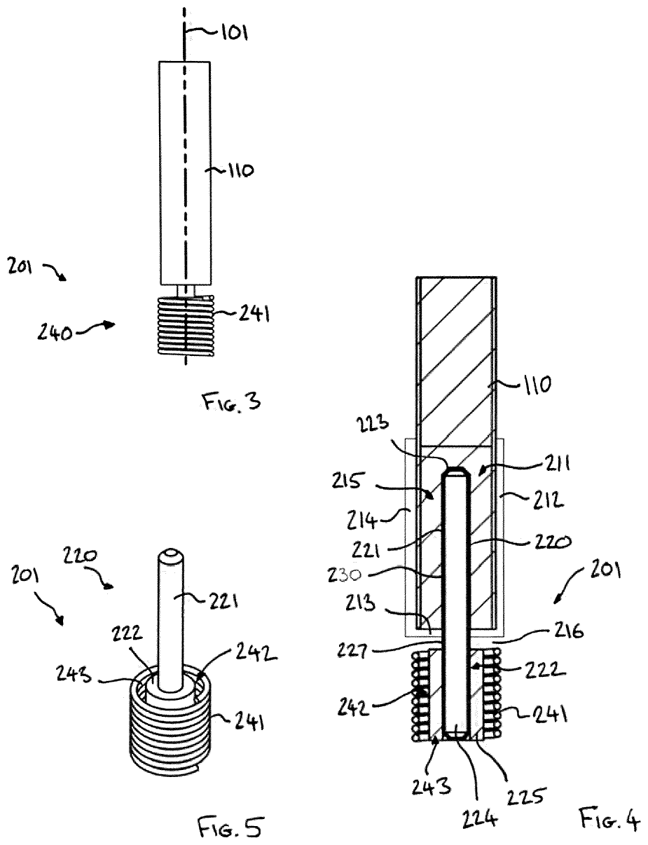

FIGS. 3, 4 and 5 illustrate an embodiment of the heating assembly 201 in more detail. It will be appreciated that the heating assembly 201 may include other components not shown in FIGS. 3 to 5.

As shown in FIGS. 3 to 5, the heating assembly 201 comprises the heating element 220 and the magnetic field generator 240. The helical inductor coil 241 of the magnetic field generator 240 is shown in the FIGS. 3 to 5.

The heating element 220 extends in the heating zone 215. The heating portion 221, acting as a protruding element, protrudes in the heating zone 215. The heating portion 221 is formed by part of the heat pipe 230. The heat pipe 230 is spaced from the peripheral wall 214. The heating assembly 201 is configured such that when an article 110 is received by the heating chamber 211, the heat pipe 230 of the heating element 220 extends into a distal end of the article 110. The heat pipe 230 of the heating element 220 is positioned, in use, within the article 110 as shown in FIGS. 3 and 4. The heating element 220 is configured to heat aerosol generating material of an article 110 from within, and for this reason is referred to as an inner heating element. To facilitate this, the inner heating element 220 is configured to pierce an article 110 that is inserted into the device 100. By providing a heat pipe extending into the article, heat transfer into the article may be maximized. A heat dispersion along the article may be more evenly applied.

In the present embodiment, the heat pipe 230 comprises a sharp edge or point at its proximal end 223. The proximal end is the free end of the heating element 220. The heating portion 221 is a pin. Other shapes are envisaged, for example the heating portion 221 in embodiments is a blade. The heat pipe 230 may extend into the heating chamber 211 from the distal end of the heating chamber 211 along the longitudinal axis 101 of the device (in the axial direction). In embodiments the heating portion 221 formed by the heat pipe 230 extends into the heating chamber 211 spaced from the axis 101. The heating portion 211 may be off-axis or non-parallel to the axis 101. Although one heat pipe 230 is shown, it will be understood that in embodiments, the heating assembly 201 comprises a plurality of heat pipes. Such heat pipe in embodiments are spaced from but parallel to each other. Such a plurality of heat pipes are disposed in an array.

The heat pipe 230 extends from the heating zone 215. The heat pipe 230 extends external to the heating zone 220. The heat pipe 230 is received through the receptacle 212. The heat pipe 230 extends through the end wall 213. The helical inductor coil 241 is disposed external to the receptacle 212. The helical inductor coil 241 is spaced from the end wall 213. A gap 216 is provided between the receptacle 212 and the helical inductor coil 241. In embodiments, an insulation member (not shown) is provided in the gap 216. In embodiments, the helical inductor coil 241 is mounted to the end wall 213. In embodiments the inductor coil 241 is spaced from the end wall 213. Base portion 222 is shown external to the heating chamber 211. The heating element 220 may comprise an intermediate portion 225 between the heating portion 221 and the base portion 222. The intermediate portion 225 may extend between the helical inductor coil 241 and the heating chamber 211. The intermediate portion 225 extends through the end wall 213. In embodiments, the intermediate portion 225 is omitted or forms part of one of the heating portion 221 and the base portion 222.

The helical inductor coil 241 extends around at least a portion of the base portion 222, acting as a susceptor. The helical inductor coil 241 is configured to generate a varying magnetic field that penetrates the base portion 222.

The inductor coil 241 is a helical coil comprising electrically-conductive material, such as copper. The coil is formed from wire, such as Litz wire, which is wound helically around a support member (not shown). The support member (not shown may be omitted. The support member is tubular. The coil 241 defines a generally tubular shape. The helical coil 241 defines an inductor zone 242, The helical coil 241 defines a bore 243.

The inductor coil 241 has a generally circular profile. In other embodiments, the inductor coil 241 may have a different shape, such as generally square, rectangular or elliptical. The coil width may increase or decrease along its length.

The base portion 222 of the heating element 220 extends into the inductor coil 241. That is, the helical inductor coil 241 defines the inductor zone 242 in an enclosed space. The inductor zone 242 is a space defined by the inductor coil 241 in which a feature is receivable to be heatable by penetration with a varying magnetic field generated by the inductor coil 241.

Other types of inductor coil may be used, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximized. By providing an enclosed inductor zone with a helical coil arrangement it is possible to aid the flux concentration of the magnetic field.

Litz wire comprises a plurality of individual wires which are individually insulated and are twisted together to form a single wire. Litz wires are designed to reduce the skin effect losses in a conductor. Other wire types could be used, such as solid.

The configuration of the helical inductor coil may vary along its axial length. For example, the inductor coil, or each inductor coil, may have substantially the same or different values of inductance, axial lengths, radii, pitches, numbers of turns, etc.

The helical inductor coil 241 may extend around, and be supported by, the support member (not shown). The helical inductor coil 241 is arranged coaxially with the heating chamber 211 and longitudinal axis 101.

Where the base portion 222 extends through the inductor zone 242 the base portion 222 is susceptible to varying magnetic flux along its length.

The heating element 220 comprises the base portion 222 with the heating portion 221 protruding from the base portion 222. The heating portion 221 is heatable by the base portion 222 by thermal conduction. The heating portion 221 and base portion 222 are thermally conductively connected. The base portion 222 has a greater radial extent than the heating portion 221. The base portion 222 is generally cylindrical, however other shapes are anticipated.

The elongate heating portion 221 extends at its distal end from the base portion 222. The elongate heating portion 221 and the base portion 222 are coaxial. The base portion 222 has an axial height. The axial height of the base portion 222 substantially corresponds to the axial length of the of the inductor zone 242. Such an arrangement aids to maximize the magnetic flux intersecting with the base portion 222.

The base portion 222 comprises a distal end of the heat pipe 230 and a collar 225. The distal end of the of the heat pipe 230 acts as a core 224. The core is formed by the heatpipe 230. In embodiments, the distal end of the heat pipe 230 abuts the collar 225 but does not extend therein. The collar 225 in embodiments is solid. The heat pipe 230 is a one-piece component. In such an arrangement the heating portion 221 is defined by the part of the heat pipe 230 extending in the heating zone 215. The core 224 is defined by the part of the heat pipe 230 extending in the collar 225.

The heat pipe 230 has a generally constant cross sectional area and profile along its length. The heat pipe 230 is conductively connected to the collar 225. Accordingly, heat transfer from the collar 225 to the heat pipe 230 occurs by conduction when the collar 225 is heated. The collar 225 forms an interference fit with the heat pipe 230. The collar 225 may be connected to the heat pipe 230 by different means. The heat pipe 230 acts to enhance heat transfer along the length of the heating element 220.

The collar 225 encircles the heat pipe 230. In embodiments the collar 225 partially encircles the heat pipe 230. In the present embodiment the collar 225 is tubular. The collar 225 defines an outer layer of the heat pipe 230. The heating portion 221 of the heat pipe 230 protrudes above the collar 225.

The heat pipe 230 has a thermal conductivity greater than the thermal conductivity of the collar 225. The collar 225 is formed from a different material. The collar 225 acts as the susceptor, and is formed from a material susceptible to being heated by penetration with the varying magnetic field. The collar 225 comprises electrically conducting material suitable for heating by electromagnetic induction. For example, the susceptor may be formed from a carbon steel. It will be understood that other suitable materials may be used, for example a ferromagnetic material such as iron, nickel or cobalt.

The collar 225 as shown in FIGS. 3 to 5 has a solid configuration. The collar 225 is shown as tubular. In embodiments the configuration of the collar differs. The collar in an embodiment is a foil layer. The collar may be an outer layer on the core 224. The collar in embodiments is a mesh. The collar, acting as the susceptor, in embodiments is a wire. The collar may comprise a plurality of wires forming a collar. In an embodiment, the wire is formed as a winding around the core. The collar may have a serpentine arrangement. It will be understood that the configuration of the wire arrangement may differ. For example, the wire arrangement forming the susceptor may have a helical configuration.

The material of the heat pipe 230 has a lower susceptibility to being heated by penetration with the varying magnetic field than the susceptibility of the collar 225. The material forming the collar 225 has a higher susceptibility to being heated by penetration with the varying magnetic field than the susceptibility of the heat pipe 230. The material of the heat pipe 230 is a non-ferrous material. The material of the collar 225 is one of a ferromagnetic and paramagnetic material.

The high thermal conductivity of the heat pipe 230 aids heat transfer. Accordingly, when the collar 225 is heated, the thermal transfer of heat along the heat pipe 230 is maximized. This aids a more uniform heating of the heating portion 221 along the axial length. Uniform heating of the heating portion 221 aids a uniform heating of the article 110. This may help to provide a consistent generation of aerosol along the length of the aerosolizable material. The high thermal conductivity of the heat pipe 230 may reduce the likelihood of hot-spots.

Although as described above the base portion 222 comprises the distal end of the heat pipe 230 and the collar 225, in embodiments, the heat pipe 230 defines the susceptor. Such an embodiment is shown in FIG. 6. It will be appreciated that a heating assembly 301 may include other components not shown in FIG. 6. The configuration of the device 100 is generally as described above and so a detailed description will be omitted.

In the configuration shown in FIG. 6, the heating assembly 301 comprises a heat pipe 330 acting as a heating element 320 and a magnetic field generator 340 acting as a heating arrangement. The magnetic field generator 340 comprises a helical inductor coil 341. The heating element 320 protrudes in the heating chamber 311 as described above. The heating element 320 does not comprise a collar forming the susceptor as described above. In this arrangement, the heat pipe 330 forms the susceptor. That is, the heat pipe 330 is formed from a material susceptible to being heated by penetration with the varying magnetic field. The heat pipe 330 is formed from a susceptor material.

The susceptor material is integrally formed in the heat pipe 330. The heat pipe 330 acts as the susceptor, and is formed from a material susceptible to being heated by penetration with the varying magnetic field. The heat pipe 330 may be formed from a carbon steel. It will be understood that other suitable materials may be used, for example a ferromagnetic material such as iron, nickel or cobalt.

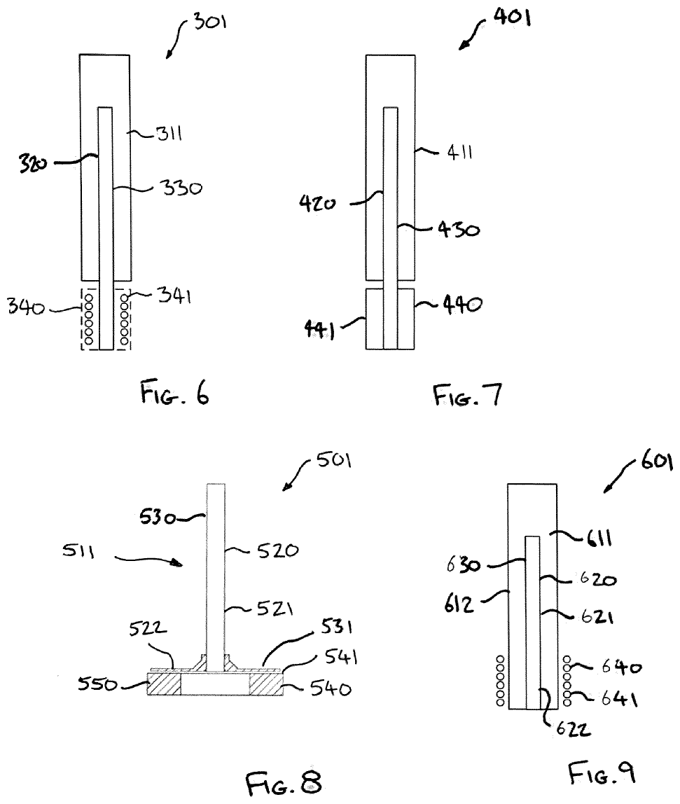

In the above described embodiments, the heating arrangement is an inductive heating arrangement. In embodiments, other types of heating arrangement are used, such as resistive heating. In the configuration shown in FIG. 7, resistive heating is used. It will be appreciated that a heating assembly 401 may include other components not shown in FIG. 7. The configuration of the device 100 is generally as described above and so a detailed description will be omitted.

In the configuration shown in FIG. 7, the heater assembly 401 comprises a resistive heating generator 440 including components to heat a heat pipe 430 via a resistive heating process. In this case, an electrical current is directly applied to a resistive heating component 441, and the resulting flow of current in the heating component 441 causes the heating component to be heated by Joule heating. A heating element 420 comprises a collar, forming the resistive heating component 441 encircling the heat pipe 430 and the heat pipe 430. The resistive heating component 441 comprises resistive material configured to generate heat when a suitable electrical current passes through it, and the heating assembly 401 comprises electrical contacts for supplying electrical current to the resistive material. The heat pipe 430 protrudes in a heating chamber 411.

In embodiments, the heat pipe 430 forms the resistive heating component 441 itself. The heat pipe 430 transfers heat to the article 110.

Other forms of heating element, such as infra-red heating elements, are contemplated. As described above for inductive heating arrangements, the inductor coil is a helical coil configuration. In other arrangements, other coil configurations are envisaged, such as a spiral coil. Such an embodiment is shown in FIG. 8. It will be appreciated that a heating assembly 401 may include other components not shown in FIG. 8. The configuration of the device 100 is generally as described above and so a detailed description will be omitted.

A spiral inductor coil 541 forming part of a magnetic field generator 540, acting as a heating arrangement, is shown in FIG. 3. The inductor coil 541 is a two-dimensional spiral on a surface of a PCB 550. The PCB 550 acts as a substrate. The substrate supports the spiral coil 541. The inductor coil 541 is defined by a film. In this embodiment, the substrate 550 is a non-electrically conductive support. That is, the substrate is an electrical insulator. In other embodiments, the support substrate may be omitted.

In the present embodiment, the spiral inductor coil 541 is deposited on a flat substrate or support. The spiral inductor coil 541 in embodiments has a three-dimensional shape, for example, the spiral inductor coil 541 may define a recess.

The spiral inductor coil 541 is an electrically conductive coil configured to conduct a varying electrical current. The spiral coil may be formed, for example, by depositing, printing, etching, chemically or mechanically bonding.

The spiral inductor coil 541 is a generally square or rectangular coil. In other embodiments, the spiral inductor coil 541 may have a different shape, such as generally circular or elliptical. In some embodiments, the spiral inductor coil 241 may be a three-dimensional spiral. In some such embodiments, the inductor coil 541 may be manufactured using an additive manufacturing technique, such as 3D printing. In this embodiment, adjacent spaced portions of the inductor coil 541 are regularly spaced. In other embodiments, such portions of the inductor coil 541 may not be regularly spaced.

The heating assembly 501 also includes a heating element 520. The heating element 520 comprises a heat pipe 530 and a base 531. The base 531 acts as the susceptor. The base 531 is heatable by a varying magnetic field generated by the spiral inductor coil 541. The base 531 is a plate. The heat pipe 530 upstands from the base 531. The heat pipe 530 forms an elongate heating portion 521. The base 531 forms part of a base portion 522 with the heating portion 521 protruding from the base portion 522. The heat pipe 530 is heatable by the base 531 by thermal conduction. The heat pipe 530 and the base 531 are thermally conductively connected. The base 531 has a greater radial extent than the heat pipe 530.

In embodiments described above the heating arrangement is axially offset from the heating chamber. For example, the helical inductor coils described above are axially spaced from the receptacle. By providing the helical inductor coil 241 offset from the receptacle 212 it is possible to aid a minimization of the radial extent of the helical inductor coil 241.

In embodiments, other types of inductive heating arrangement are used, such as in an embodiment shown in FIG. 9 in which the inductor coil overlaps the heating chamber. It will be appreciated that a heating assembly 601 may include other components not shown in FIG. 9. The configuration of the device 100 is generally as described above and so a detailed description will be omitted.

In the configuration shown in FIG. 7, the heating assembly 601 comprises a heat pipe 630 acting as a heating element 620 and a magnetic field generator 640 acting as a heating arrangement. The magnetic field generator 640 comprises a helical inductor coil 641. The heating element 620 protrudes in the heating chamber 611 as described above. In this arrangement, the heat pipe 630 forms the susceptor. That is, the heat pipe 630 is formed from a material susceptible to being heated by penetration with the varying magnetic field. The heat pipe 630 is formed from a susceptor material. The heat pipe 630 may be formed from a carbon steel. It will be understood that other suitable materials may be used, for example a ferromagnetic material such as iron, nickel or cobalt. In another embodiment the heating element 630 comprises a collar (not shown). In such an embodiment, the collar is formed from a material susceptible to being heated by penetration with the varying magnetic field. The heat pipe 630 may be formed from a material that is non-susceptible or less susceptible to being heated by penetration with the varying magnetic field.

A receptacle 612 defines the heating chamber 611. The helical inductor coil 641 overlaps the heating chamber 611. With such an arrangement, the heating element 620 does not extend from the heating chamber 611. The heating element 620 is heated directly by the coil in the heating chamber 611.

As shown in FIG. 9, the coil 641 partially overlaps the heating element 620. The heat pipe 630 aids heat distribution along the heating element 620 between a base portion 622 overlapping the coil 641 and a heating portion 621 offset from the coil 641. In embodiments, the heat pipe 630 is encompassed by the coil 641.

In the above described embodiments the heating portion is an inner heater. That is, the heating portion protrudes into the heating chamber and is arranged to be received by the article. In another embodiment the heating portion is an outer heater. In such a configuration, the heating member may be a generally tubular member extending along and substantially coaxial with the longitudinal axis 101. The heating member may extend at least partially around an axial portion of the heating chamber. The heating member may extend continuously around the entire circumference of the heating chamber, or only partially extend around the chamber. For example, one or more discontinuities, e.g. holes, gaps or slots, may be provided in the heating member. The heating member may be configured and dimensioned to extend around an article received by the heating chamber. The heating member may thus be positioned, in use, around an article. The heating member may thus be configured to heat aerosol generating material of the article 110 from outside, and for this reason be referred to as an outer heating element. The heating member may have a circular cross section, e.g. corresponding a circular cross section of the article 110. Other cross sectional shapes would be possible.

The heating member may extend along the heating region for any suitable distance. The heating member in such an embodiment may form the receptacle. The base portion is disposed at an end of the tubular member. The outer heating member may form the tubular member at one end. The base portion in such embodiments may extend one or both of axially or radially inwardly. The base portion may define the end wall. The base collar in some embodiments is a collar around the tubular member.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus for heating aerosolizable material to volatize at least one component of the aerosolizable material, the apparatus comprising:
a heating assembly comprising:
a heating cavity arranged to receive at least a portion of an article comprising aerosolizable material,
a heating element arranged to provide heat to the heating cavity, and
a heating arrangement configured to generate heat to heat the heating element;
wherein the heating element comprises a heat pipe.

2. The apparatus of claim 1, wherein the heating element protrudes in the heating cavity.

3. The apparatus of claim 1, wherein the heat pipe protrudes in the heating cavity.

4. The apparatus of claim 1, wherein the heat pipe is configured to be at least partially received in the article comprising the aerosolizable material.

5. The apparatus of claim 1, wherein the heat pipe is arranged to transfer heat external to the heating cavity into the heating cavity.

6. The apparatus of claim 1, wherein the heating element has an effective thermal conductivity of greater than 3000 W/m-k.

7. The apparatus of claim 1, wherein the heating arrangement is configured to apply heat at one end of the heat pipe.

8. The apparatus of claim 7, wherein the heating arrangement encircles part of the heat pipe.

9. The apparatus of claim 8, wherein a portion of the heat pipe extends away from the heating arrangement.

10. The apparatus of claim 9, further comprising a portion of the heat pipe extending external to the heating cavity.

11. The apparatus of claim 10, wherein the heating arrangement is arranged to heat the portion of the heat pipe extending external to the heating cavity.

12. The apparatus of claim 11, further comprising a collar configured to heat the heat pipe.

13. The apparatus of claim 12, wherein the collar comprises heating material that is heatable by penetration with a varying magnetic field.

14. The apparatus of claim 1, wherein the heat pipe comprises heating material that is heatable by penetration with a varying magnetic field.

15. The apparatus of claim 13, wherein the heating arrangement comprises a magnetic field generator including an inductor coil configured to generate a varying magnetic field.

16. The apparatus of claim 15, wherein the inductor coil is a helical inductor coil.

17-19. (canceled)

20. An apparatus for heating aerosolizable material to volatize at least one component of the aerosolizable material, the apparatus comprising:
a heating assembly comprising a heating cavity arranged to receive at least a portion of an article comprising aerosolizable material;
a heating element arranged to provide heat to the heating cavity; and
a heating arrangement configured to generate heat to heat the heating element;
wherein the heating element has an effective thermal conductivity of greater than 3000 W/m-k.

21. An elongate heating element for use in apparatus for heating aerosolizable material to volatilize at least one component of the aerosolizable material, wherein the elongate heating element comprises:
a heat pipe comprising a susceptor portion heatable by penetration with a varying magnetic field.

22. An aerosol provision device comprising:
one of an elongate heating element for use in an apparatus for heating aerosolizable material to volatilize at least one component of the aerosolizable material, wherein the elongate heating element comprises a heat pipe comprising a susceptor portion heatable by penetration with a varying magnetic field; and
one of the apparatus of claim 1.

23. An aerosol provision system comprising the aerosol provision device of claim 22, and an article comprising aerosol generating material.

24. (canceled)
